(19) United States
(12) Patent Application Publication
(10) Pub. No.: US 2008/0054066 A1
(43) Pub. Date: Mar. 6, 2008

(54) Method, System and Program Product Supporting Sharing of Transaction Data Associated with a Rewards Program Identifier

(76) Inventors: Alexander C. Johnson, Portland, OR (US); Scott W. Nelson, Beaverton, OR (US); Hal A. Porter, Portland, OR (US); Joshua R. Poulson, Ridgefield, WA (US)

Correspondence Address: DILLON & YUDELL, LLP, 8911 N CAPITAL OF TEXAS HWY, SUITE 2110, AUSTIN, TX, 78759, US

(21) Appl. No.: 11/469,994

(22) Filed: Sep. 5, 2006

(51) Int. Cl. G06K 5/00; G06Q 30/00

(52) U.S. Cl. 235/380; 705/14

(57) ABSTRACT

At a point-of-sale terminal, a rewards program identifier of a customer is associated with a transaction described by detailed transaction data. The detailed transaction data are recorded at a point-of-sale server such that the detailed transaction data is associated with the customer. The detailed transaction data are also communicated from the point-of-sale server to a data processing system of the customer over a network and imported into a financial software application executing on the data processing system of the customer.

### BACKGROUND OF THE INVENTION

1. Technical Field

The present invention relates in general to the field of computer software and in particular to financial software. Still more particularly, the present invention relates to an improved method and system for electronically sharing transaction data associated with a rewards program identifier.

2. Description of the Related Art

Financial software applications, such as Quicken® and Microsoft Money®, allow computer users to electronically record financial transactions, such as deposits and withdrawals, and facilitate the preparation of various financial reports. For example, both individual consumers and business entities utilize financial software applications to track expenditures, prepare budgets, and forecast future profits. Financial software applications typically allow a computer user to easily categorize monetary transactions by keeping track of specific details for each transaction, such as the date, location, product/service type, and number of instances of each product/service.

Conventional financial software applications do however have drawbacks. For example, because conventional personal financial software applications rely upon manual data entry, particularly for cash transactions, transaction data is frequently not entered or erroneously entered by the user. Furthermore, since paper receipts of cash, credit and debit transactions typically contain sparse information regarding the transactions, users of personal financial software applications must often make hand written annotations on the receipts shortly after the time of purchase in order to accurately document the details of the transaction for subsequent data entry.

The present invention thus recognizes that an improved method, system and program product for entering detailed transaction data into a customer's financial software application is needed.

### SUMMARY OF THE INVENTION

At a point-of-sale terminal, a rewards program identifier of a customer is associated with a transaction described by detailed transaction data. The detailed transaction data are recorded at a point-of-sale server such that the detailed transaction data is associated with the customer. The detailed transaction data are also communicated from the point-of-sale server to a data processing system of the customer over a network and imported into a financial software application executing on the data processing system of the customer.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary data processing environment in accordance with the present invention; and

FIG. 2 is a high level logical flowchart of an exemplary method of communicating detailed transaction data to a customer's financial software application in accordance with one embodiment of the invention.

### DETAILED DESCRIPTION OF AN ILLUSTRATIVE EMBODIMENT

The present invention provides a method, system, and computer program product for entering detailed transaction data captured at the point-of-sale into a customer's financial software application.

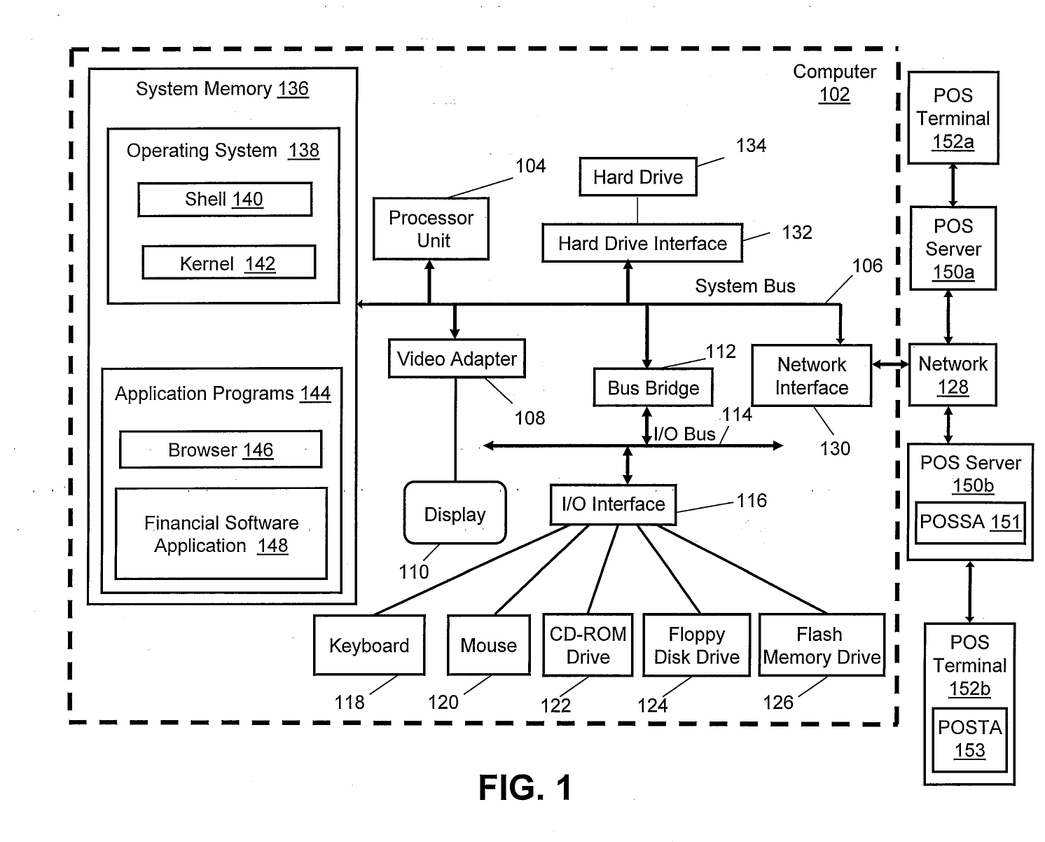

With reference now to FIG. 1, there is depicted a block diagram of an exemplary data processing system environment in accordance with the present invention. As depicted, the data processing system environment includes a customer's computer 102, which may be a desktop or laptop personal computer, handheld computer, workstation, or other data processing system. Computer 102 includes processor unit 104 that is coupled to system bus 106. Video adapter 108, which drives/supports display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk-Read Only Memory (CD-ROM) drive 122, floppy disk drive 124, and flash drive memory 126. The format of the ports connected to I/O interface 116 may be any known to those skilled in the art of computer architecture, including but not limited to Universal Serial Bus (USB) ports.

Computer 102 is able to communicate with a plurality of point-of-sale (POS) servers 150a and 150b via network 128 using network interface 130, which is coupled to system bus 106. Network 128 may be an external network such as the Internet. POS servers 150a and 150b are provided solely for illustration, and the number of POS servers 150 may be more than two. According to the illustrative embodiment, POS servers 150a, 150b obtain POS data regarding consumer financial transactions from POS terminals 152a, 152b, and computer 102 accesses such data from POS server 150a and/or 150b via network 128. POS servers 150 and POS terminals 152 may both be realized as general-purpose data processing systems like computer 102 or may be alternatively be implemented with special purpose POS data processing hardware, as known to those skilled in the art. POS servers 150 execute POS server application (POSSA) 151 to provide transaction data to computer 102, and POS terminals 152 execute POS terminal application (POSTA) 153 to provide POS functionality, which in accordance with the present invention includes selective output of POS transactions as described further below.

Hard drive interface 132 is also coupled to system bus 106. Hard drive interface 132 interfaces with hard drive 134. In a preferred embodiment, hard drive 134 populates system memory 136, which is also coupled to system bus 106. System memory is defined as a lowest level of volatile memory in computer 102. This volatile memory may include additional higher levels of volatile memory (not shown), including, but not limited to, cache memory, registers, and buffers. Code that populates system memory 136 includes operating system (OS) 138 and application programs 144.

OS 138 includes shell 140, for providing transparent user access to resources such as application programs 144. Generally, shell 140 (as it is called in UNIX®) is a program that provides an interpreter and an interface between the user and the operating system. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and mouse and keyboard management.

Application programs 144 include browser 146. Browser 146 includes program modules and instructions enabling a World Wide Web (WWW) client (i.e., computer 102) to send and receive network messages to the Internet. Computer 102 may utilize HyperText Transfer Protocol (HTTP) messaging to enable communication with POS server 150a and/or 150b. Application programs 144 in system memory 136 also include financial software application 148.

The hardware elements depicted in computer 102 are not intended to be exhaustive, but rather represent and/or highlight certain components that may be utilized to practice the present invention. For instance, computer 102 may include alternate memory storage devices such as magnetic cassettes, Digital Versatile Disks (DVDs), Bernoulli cartridges, and the like. These and other variations are intended to be within the spirit and scope of the present invention.

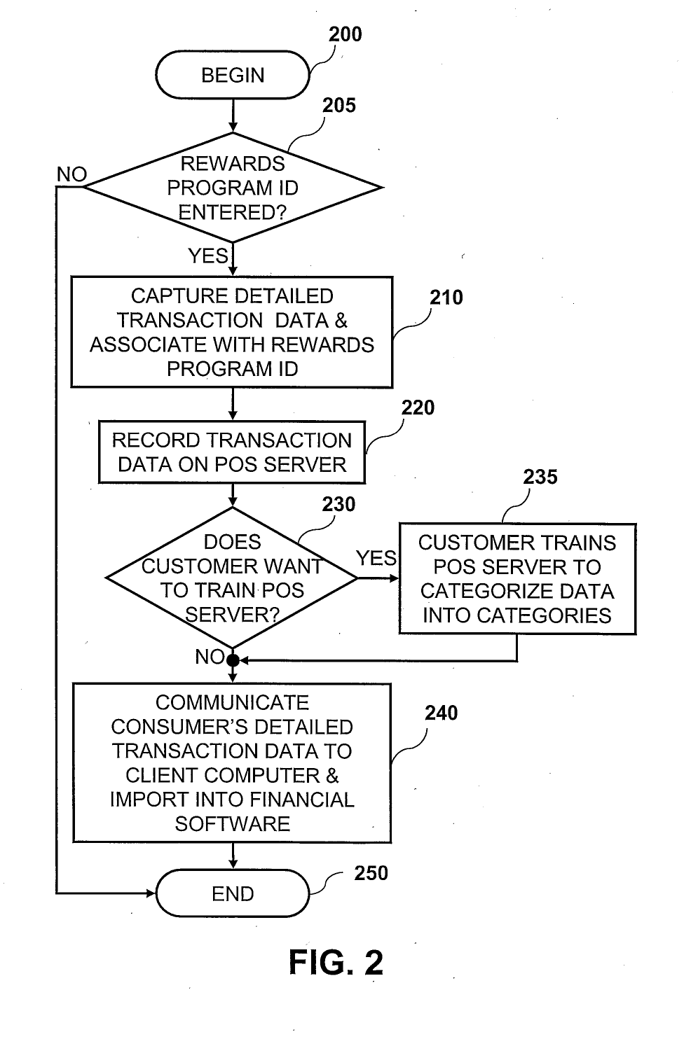

With reference now to FIG. 2, there is illustrated a high level logical flowchart of an exemplary method of entering detailed transaction data captured at a point-of-sale into a financial software application, such as financial software application 148, in accordance with one embodiment of the invention. In some embodiments, the depicted method may be performed by software in a substantially automated fashion, for example, by a POS terminal application (POSTA) 153 executing on a POS terminal 152, a POS server application (POSSA) executing on a POS server 150, and financial software application 148 executing on computer 102. In other embodiments, user interaction is necessary, as discussed below.

The process begins at block 200 in response to a customer making a purchase of goods and/or services from a vendor employing POS terminal 152. In association with entry of information related to the transaction at POS terminal 152, for example, by electronic scanning or manual keyed entry, POSTA 153 determines at block 205 whether a rewards program identifier of a customer has been entered in association with the transaction, for example, by scanning a bar code on a physical rewards or loyalty card or by manually keyed entry of the rewards program identifier (e.g., a customer telephone number, credit/debit card number, bank account number, or vendor-assigned rewards card number). A rewards program identifier is defined herein as any identifier associated with a customer by a vendor that allows the vendor to track the transactions of that specific customer over time, whether or not the vendor financially or otherwise rewards the customer. As will be appreciated, vendors having conventional customer rewards/loyalty card programs typically collect detailed purchase data for business development and advertising purposes and do not conventionally share the collected purchase data with customers.

In response to POSTA 153 determining at block 205 that a customer's reward program identifier has not been entered, detailed purchase data may not be uniquely associated with the customer, and the process terminates at block 245. If, however, POSTA 153 determines at block 205 that a customer's reward program identifier has been entered, POSTA 153 captures detailed transaction data regarding the goods, services and/or other benefits exchanged between the customer and vendor in the transaction. In one embodiment, detailed transaction data includes, without limitation, the transaction date, geographic location of POS terminal 152, and if applicable, the product name, price, product type, and count. These detailed transaction data are associated with the rewards program identifier by POSTA 153.

At block 220, the detailed transaction data is stored in association with the rewards program identifier within a POS server 150 coupled to the POS terminal 152 utilized to facilitate the transaction. Depending upon the desired implementation, detailed transaction data may be “pushed” to POSSA 151 executing on POS server 150 by POSTA 153 or may be “pulled” from POSTA 153 by POSSA 151.

According to the illustrative embodiment, a customer may make purchases at a plurality of vendors, each of which may be located at a different geographic location. Furthermore, each vendor may also utilize a different storage location from among a plurality of POS servers, such POS servers 150a and 150b. In an alternate embodiment, detailed purchase data collected from a plurality of unaffiliated vendors may instead be stored, for example, by an independent third party service provider, on a single POS server 150. In such an embodiment, customers could be differentiated at the POS via an electronic keycard associated with the independent third party. The independent third party can also provide aggregate data captured from a plurality of consumers to vendors for business development and advertising purposes.

As depicted at block 230, POSSA 151 also determines at block 230 if an input has been received from computer 102 (e.g., from browser 146 or financial software application 148) indicating that the customer would like to train POSSA server 151 to categorize detailed transaction data utilizing consumer-defined categories. If not, the process passes to block 240, which is described below. If, however, POSSA 151 has received such an input, POSSA 151 presents an interface through which the customer is permitted to set and/or modify the number and names of categories and to teach POSSA 151 how to categorize transactions based upon the content of the detailed transaction data, as depicted at block 235. For example, the customer can train POSSA 151 to categorize particular expenditures as “tax deductible” or “reimbursable.”

At block 240, a customer's categorized detailed transaction data is communicated from POS server 150 to computer 102 via network 128 and imported into financial application software 148. As discussed above with regard to the transfer of detailed transaction data between POS terminal 152 and POS server 150, communication of detailed transaction data from POS server 150 to computer 102 can be initiated by computer 102 (i.e., “pulled”) or by POS server 150 (i.e., “pushed”). If pulled from POS server 150 by computer 102, the transmission of the detailed transaction data can be initiated by browser 146 or financial software application 148, either automatically or in response to a user input, preferably after authentication by POSSA 151 or web server software executing on POS server 150.

The communication of detailed transaction data and its importation into financial software application 148 can further be performed in a single step or in a sequence of two or more steps. If performed in a single step, financial software application 148 preferably establishes a secure application layer connection to POSSA 151 (or a web server) executing on POS server 150 and directly imports the detailed transaction data via the connection. If performed in a sequence of multiple steps, the detailed transaction data is communicated in an electronic data file, for example, a comma separated value (CSV) file or database file, and then imported into financial software application 148, possibly in response to user input and after additional data transformation. In the case of a multi-step process, the transmission of the data file can be performed by email (e.g., SMTP), HTTP, FTP or other communication protocol.

Following the importation of the detailed transaction data into financial software application 148, the process terminates at block 250. Thereafter, the user may utilize financial software application 148 to manipulate the categorized detailed transaction data in order to prepare various types of financial reports and analysis, as is known in the art. Such reports may be presented in a variety of ways, including by displaying the report within display 110 and/or printing the report on a printer.

As has been described, the present invention provides a method, system, and program product for capturing data regarding commercial transactions for use in a financial software application. Detailed transaction data, including the transaction date, transaction location, the product, service or benefit that was the subject of the transaction, and if a product, the product name, product price, and product type, is captured by a POS terminal. The detailed transaction data is associated with a particular customer's rewards program identifier at the POS terminal, for example, by swiping the customer's loyalty/reward card. The detailed transaction data are then be recorded electronically at a POS server. The stored detailed transaction data is communicated to the customer's computer and imported into a financial software application for reporting and/or analysis. The user may further establish and customize preferences for the categorization of transaction data and train the POS server to categorize the detailed transaction data in accordance with the customer's preferred categories.

While the invention has been particularly shown and described with reference to a preferred embodiment, it will be understood by those skilled in the art that various changes in form and detail may be made therein without departing from the spirit and scope of the invention. For example, although an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CDROMs, DVDs, and transmission type media such as digital and analog communication links.

What is claimed is:

1. A method of data processing, comprising:
at a point-of-sale terminal, associating a rewards program identifier of a customer with a transaction, the transaction being described by detailed transaction data;
recording the detailed transaction data at a point-of-sale server such that the detailed transaction data is associated with the customer;
communicating the detailed transaction data from the point-of-sale server to a data processing system of the customer over a network; and
importing the detailed transaction data into a financial software application executing on the data processing system of the customer.

2. The method of claim 1, wherein said recording step comprises recording the detailed transaction data in association with the rewards program identifier.

3. The method of claim 1, wherein said communicating comprises said point-of-sale server initiating push communication of the detailed transaction data to the data processing system of the customer.

4. The method of claim 1, wherein said communicating comprises said data processing system initiating pull communication of the detailed transaction data to the data processing system via a website associated with the point-of-sale server.

5. The method of claim 4, wherein said financial software application initiates communication of said detailed transaction data in response to a user input.

6. The method of claim 1, and further comprising the data processing system generating and presenting a report utilizing said detailed transaction data.

7. A data processing system, comprising:
a point-of-sale terminal that associates a rewards program identifier of a customer with a transaction, the transaction being described by detailed transaction data; and
a point-of-sale server, coupled to the point-of-sale terminal, that records the detailed transaction data at a point-of-sale server such that the detailed transaction data is associated with the customer and communicates the detailed transaction data from the point-of-sale server to a data processing system of the customer over a network, such that the detailed transaction data can be imported into a financial software application executing on the data processing system of the customer.

8. The data processing system of claim 7, wherein said point-of-sale server records the detailed transaction data in association with the rewards program identifier.

9. The data processing system of claim 7, wherein said point-of-sale server initiates push communication of the detailed transaction data to the data processing system of the customer.

10. The data processing system of claim 7, wherein said point-of-sale server communicates the detailed transaction data to a data processing system of the customer via a website associated with the point-of-sale server.

11. The data processing system of claim 10, and further comprising the data processing system of the customer, wherein said financial software application initiates communication of said detailed transaction data in response to a user input.

12. The data processing system of claim 11, wherein the data processing system generates and presents a report utilizing said detailed transaction data.

13. A program product, comprising:
a tangible computer readable medium; and
program code stored within the tangible computer readable medium that causes a data processing system to perform the steps of:
at a point-of-sale terminal, associating a rewards program identifier of a customer with a transaction, the transaction being described by detailed transaction data;
recording the detailed transaction data at a point-of-sale server such that the detailed transaction data is associated with the customer; and
communicating the detailed transaction data from the point-of-sale server to a data processing system of the customer over a network.

14. The program product of claim 13, wherein said recording step comprises recording the detailed transaction data in association with the rewards program identifier.

15. The program product of claim 13, wherein said communicating step comprises said point-of-sale server initiating push communication of the detailed transaction data to the data processing system of the customer.

16. The program product of claim 13, wherein said communicating step comprises the data processing system of the customer initiating pull communication of the detailed transaction data via a website associated with the point-of-sale server.

17. The program product of claim 16, wherein a financial software application initiates communication of said detailed transaction data in response to a user input.

18. The program product of claim 13, wherein said program code further causes the data processing system to generate and present a report utilizing said detailed transaction data.
